(19) United States
(12) Patent Application Publication
(10) Pub. No.: US 2006/0026016 A1
(43) Pub. Date: Feb. 2, 2006

(54) Method of associating management subject with management procedure

(76) Inventors: Masanori Honda, Sagamihara (JP); Atsushi Murase, Sagamihara (JP); Takaki Kuroda, Tokyo (JP); Masahide Sato, Noda (JP); Yusuke Izumida, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/959,170

(22) Filed: Oct. 7, 2004

(30) Foreign Application Priority Data
Jul. 28, 2004 (JP) 2004-220221

(51) Int. Cl. G06Q 99/00

(52) U.S. Cl. 705/1

(57) ABSTRACT

To provide a technique to sort out a tangle of management procedures and management subjects and associate the two with each other. A computer system according to this invention includes: a storage system having plural disks and a disk array control unit; and a management device having a control unit that uses a jobnet to manage the storage system. In the computer system, the control unit obtains data corresponding to an identifier of a resource that is included in the jobnet, converts the jobnet into an executable format by rewriting and substituting the identifier with a display name or attribute of the resource, and registers an association between a jobnet identifier and a resource identifier in a database.

### CLAIM OF PRIORITY

The present application claims priority from Japanese application P2004-220211 filed on Jul. 28, 2004, the content of which is hereby incorporated by reference into this application.

### BACKGROUND

This invention relates to a computer system handling a jobnet, which uses a job scheduler to automatically execute routine storage management tasks. More specifically, the invention relates to a technique that associates a jobnet with a resource.

Storage administrators utilize storage management software in order to manage ever increasing storage capacity and storage systems which are becoming more and more complicated. Storage management software has a function of managing storage devices and their configurations, a function of helping a storage administrator to set the storage devices, a function of automatically executing a management procedure defined in advance, and other features.

The storage administrator uses a GUI provided by the storage management software to display a management subject visually and manage the configuration and state of the management subject. Management subjects are, for example, physical or logical storage devices, and instances and tables provided by a DBMS.

Management procedures of such management subjects can be defined by (1) directly defining a procedure to a management subject or (2) separately defining a management procedure that is designed for a combination of plural management subjects. Method (1) is suitable for a simple procedure having a single management subject, for example, reallocation for a logical disk with insufficient capacity. In contrast, Method (2) is suitable for a complicated procedure having more than one management subject, for example, a periodical backup of a database built on a large-scale storage system.

For the storage management described above, a state display method has been proposed which enables a viewer to understand intuitively the association between software modules constituting the system and which uses icons and lines to graphically display the operation state of and dependency relation between the software module groups on a state display screen by displaying the causal relation between the software modules upon occurrence of a failure (refer to JP 2000-181756 A).

### SUMMARY

This prior art is capable of defining a management procedure to a single management subject as in Method (1). However, to define a complicated management procedure which deals with plural management subjects as in Method (2), the prior art needs to separately define a management procedure (jobnet) to a jobnet scheduler or the like and then specify management subjects as attributes (command arguments and parameters) of jobs in the jobnet. This leaves a user who desires to know which management subjects are contained in the thus defined management procedure no other option than to check the jobnet definition. In addition, the management procedure is not displayed on a GUI which is a storage management tool since management procedures themselves are not management subjects. Accordingly, a user cannot know which management procedure a certain management subject is used in unless the user checks the jobnet definition with his or her own eyes.

A problem which arises at this point is that there is no way to associate a management procedure and a management subject defined in the management procedure with each other. For instance, when the same resource is defined to the storage management software and to the jobnet scheduler, the association between the two is unknown to users; the two may represent the same resource, or merely a comment, or the same DBMS instance name as the name of the resource. Having been designed and implemented separately from the storage management software, the jobnet scheduler does not have information on management subjects that are handled inside the storage management software. This necessitates an additional work of associating a management procedure (jobnet) created by the jobnet scheduler with a management subject. It is therefore an object of this invention to provide a technique to sort out a tangle of management procedures and management subjects and associate the two with each other.

According to an embodiment of this invention, there is provided a computer system including: a storage system having plural disk drives and a disk array control unit; and a management device having a control unit that manages the storage system by useing a jobnet. The control unit obtains data corresponding to an identifier of a resource that is included in the jobnet, converts the jobnet into an executable format by translating the identifier with a display name or attribute of the resource, and registers an association between a jobnet identifier and a resource identifier in a database.

According to the embodiment of this invention, management procedures and management subjects can easily be associated with each other.

### BRIEF DESCRIPTION OF THE DRAWINGS

The present invention can be appreciated by the description which follows in conjunction with the following figures, wherein:

FIG. 1 is a configuration diagram of a computer system according to an embodiment of this invention.

FIG. 2 is a block diagram of a storage system according to a first embodiment.

FIG. 3 is a functional block diagram of the first embodiment.

FIG. 4A and FIG. 4B are explanatory diagrams of a jobnet according to the first embodiment.

FIG. 5 are configuration diagrams of resource information according to the first embodiment.

FIG. 6 is a schematic diagram of jobnet information according to the first embodiment.

FIG. 7A to FIG. 7E are schematic diagrams of association information according to the first embodiment.

FIG. 8 is a flowchart of processing by a jobnet definition pre-processing program according to the first embodiment.

FIG. 9A to FIG. 9C are schematic diagrams of a resource list according to the first embodiment.

FIG. 10 is a functional block diagram of a second embodiment.

FIG. 11 is an explanatory diagram of a jobnet according to the second embodiment.

FIG. 12 is a flowchart of processing by a template processing program according to the second embodiment.

FIG. 13 is an explanatory diagram of a screen and pre-processing of the template processing program according to the second embodiment.

### DETAILED DESCRIPTION OF THE PREFERRED EMBODIMENTS

Embodiments of this invention will be described below with reference to the accompanying drawings.

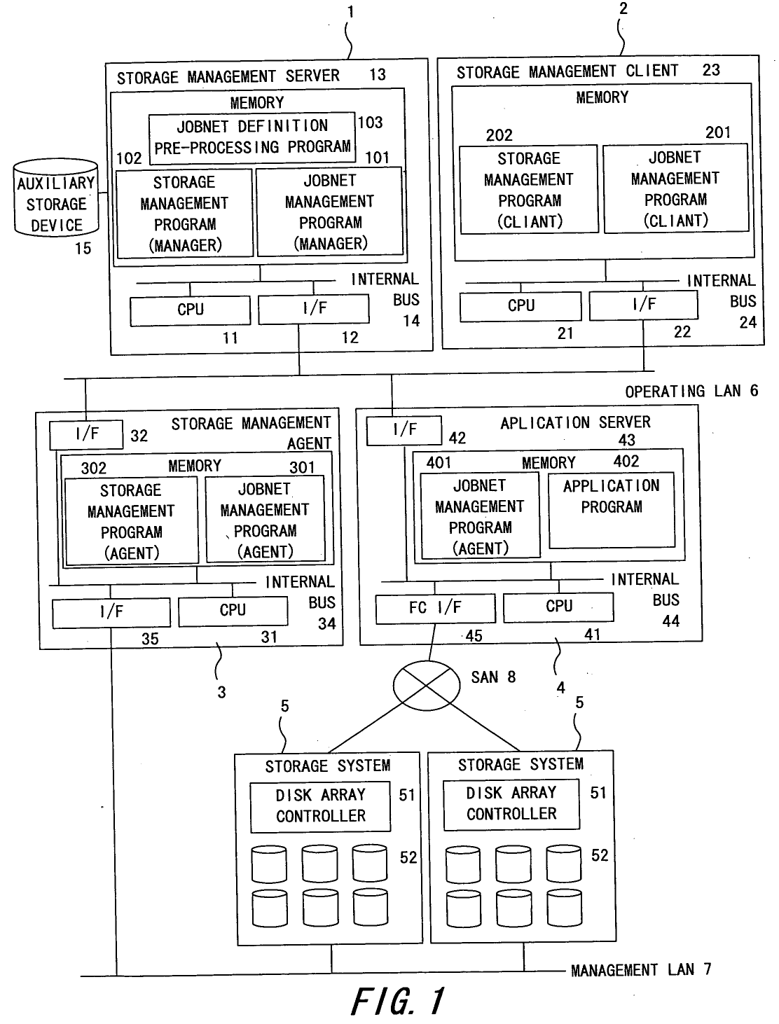

FIG. 1 is a configuration diagram of a computer system according to an embodiment.

The computer system of this embodiment is composed of a storage management server 1, a storage management client 2, a storage management agent 3, a application server 4, storage systems 5, and networks 6, 7, and 8 which couple the aforementioned components.

The storage management server 1 is a computer device equipped with a CPU 11, a network interface (I/F) 12, a memory 13, and input/output devices (such as a keyboard and a display device). The network interface (I/F) 12 is coupled to the operating LAN 6. The CPU 11, the I/F 12, and the memory 13 are connected by an internal bus 14. The memory 13 stores a jobnet management program (manager) 101, a storage management program (manager) 102, and a jobnet definition pre-processing program 103. The jobnet management program 101 cooperates with jobnet management programs 202 and 302 to perform, under operation by a user, processing related to jobnets such as definition, execution, monitoring, operation, and the like of a jobnet. The storage management program 102 cooperates with the jobnet management programs 202 and 302 to perform, under operation by a user, processing related to resources such as display, monitoring, operation, and the like of a resource. The jobnet definition pre-processing program 103 analyzes the contents of a jobnet before implementing the jobnet and creates association information 126, which describes the association between the jobnet and a resource.

An auxiliary storage device 15 composed of a magnetic disk is connected to the storage management server 1. The auxiliary storage device 15 stores programs executed on the storage management server 1 and data necessary to execute the programs. The programs and data are loaded onto the memory 13 as the storage management server 1 is activated, to be executed by the CPU 11.

It is therefore desirable to store a database 123 for use in resource-related processing, which will be described later, in the memory 13. However, the auxiliary storage device 15 may instead store the database 123.

The storage management client 2 is a computer device equipped with a control device (CPU) 21, a network interface (I/F) 22, a memory 23, and input/output devices (such as a keyboard and a display device). The network interface (I/F) 22 is coupled to the operating LAN 6. The CPU 21, the I/F 22, and the memory 23 are connected by an internal bus 24. The memory 23 stores a jobnet management program (client) 201 and a storage management program (client) 202.

The storage management agent 3 is a computer device equipped with a control device (CPU) 31, a network interface (I/F) 32, a memory 33, and a network interface (I/F) 35. The network interface (I/F) 32 is coupled to the operating LAN 6. The network interface (I/F) 35 is coupled to the management LAN 7. The CPU 31, the I/F 32, the memory 33, and the I/F 35 are connected by an internal bus 34. The memory 33 stores a jobnet management program (agent) 301 and a storage management program (agent) 302.

The application server 4 is a computer device equipped with a CPU 41, an interface (I/F) 42, a memory 43, and a fibre channel interface (I/F) 45. The network interface (I/F) 42 is coupled to the operating LAN 6. The FC I/F 45 is coupled to the Storage Area Network 8. The CPU 41, the I/F 42, the memory 43, and the FC I/F 45 are connected by an internal bus 44. The memory 43 stores a jobnet management program (agent) 401 and a application program 402.

The application program 402 is a program that executes an business according to a request made to the application server 4. The application program 402 constitutes, for example, a database management system which utilizes a disk array of the storage system 5.

Although the auxiliary storage device 15 is provided only for the storage management server 1 in FIG. 1, the storage management client 2, the storage management agent 3, and the application server 4 may also have their own auxiliary storage devices.

The storage management server 1, the storage management client 2, the storage management agent 3, and the application server 4 are coupled by the operating LAN 6. The operating LAN 6 is a network which enables computers to exchange data and control signals by, for example, the TCP/IP protocol. commonly, Ethernet is used in the operating LAN 6.

The storage system 5 has a disk array controller 51 and plural disk drives 52. The storage system 5 is coupled to the application server 4 via the Storage Area Network (SAN) 8. The SAN 8 is a network which uses a protocol suitable to transfer data, such as the fibre channel protocol or the iSCSI protocol.

The storage system 5 is also coupled to the storage management agent 3 via the management LAN 7. The management LAN 7 is, as is the operating LAN 6 described above, a network which enables computers to exchange data and control signals by, for example, the TCP/IP protocol.

The storage management server 1, the storage management client 2, the storage management agent 3, and the application server 4 are provided separately in this embodiment. Some or all of these computer devices may be integrated into one hardware since this invention can take various modes.

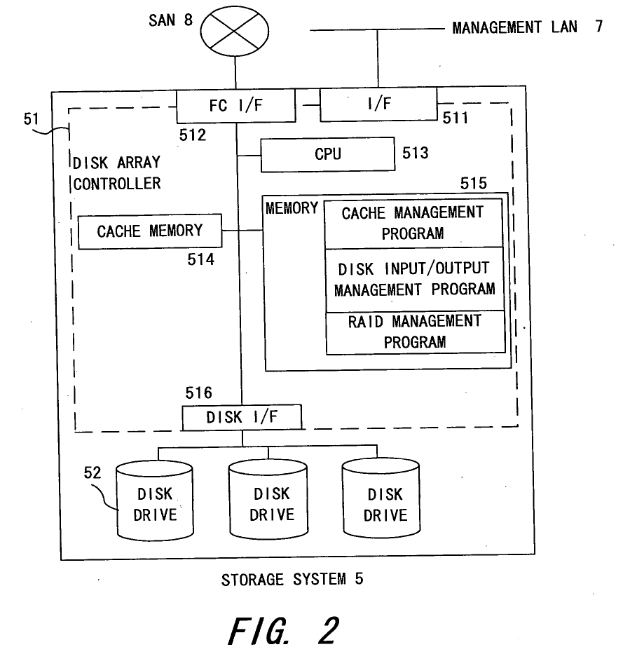

FIG. 2 is a block diagram of the storage system 5 according to a first embodiment.

The storage system 5 has the disk array controller 51 and the plural disk drives 52.

The disk array controller 51 includes a network interface (I/F) 511, an fibre channel interface (FC I/F) 512, a CPU 513, a cache memory 514, a memory 515, and a disk interface 516.

The network interface 511 is coupled to the operating LAN 6 to control communications between other computer devices (e.g., the storage management server 1) via the operating LAN 6.

The FC interface 512 is an interface for the application server 4, and exchanges data and control signals with the application server 4 via the SAN 8.

The CPU 513 executes various processing by loading control programs from the memory 515 and executing the programs. For instance, the CPU 513 controls data transfer among the FC interface 512, the cache memory 514, and the disk drives 52. The CPU 513 also manages RAID (Redundant Array of Independent Disks) constituted of the disk drives 52.

The cache memory 514 is a memory for temporarily storing data to be transferred between the FC interface 512 and the disk drives 52.

The memory 515 is a volatile or non-volatile memory, and stores various programs (including a cache management program, a disk input/output management program, and a RAID management program). A work area necessary for the CPU 513 to calculate is provided in the memory 515.

The disk interface 516 is an interface for the disk drives 52, and exchanges data and control signals with the disk drives 52 using a protocol such as ATA, SAS, or fibre channel.

The disk drives 52 are storage devices for storing data. Magnetic disk devices, for example, can be employed as the disk drives 52. The disk drives 52 constitute RAID (Redundant Array of Independent Disks), which improves the disk read/write performance by dividing user data among plural disks and inputting or outputting pieces of the user data. The RAID also gives redundancy to stored data, so that a failure in some of the disk drives does not lead to loss of stored data.

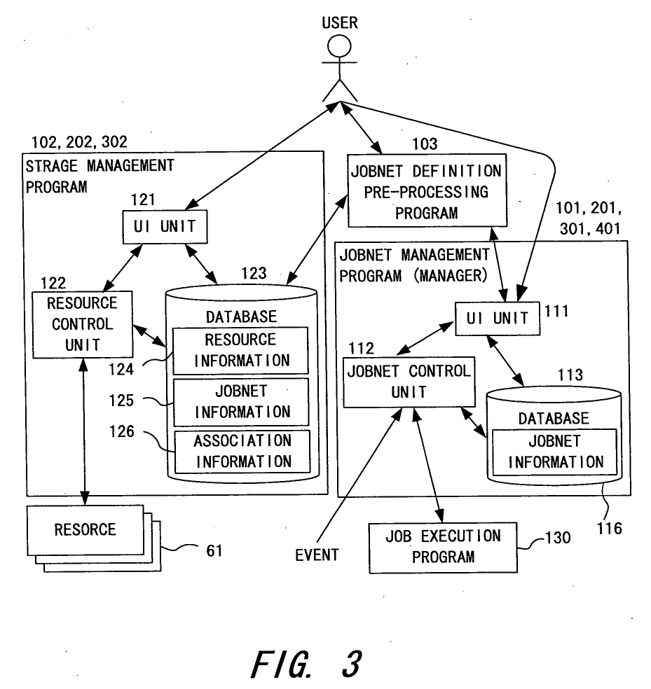

FIG. 3 is a functional block diagram of the first embodiment.

A user defines a jobnet to the jobnet definition pre-processing program 103. An identifier for identifying a management subject (resource) is attached to a jobnet defined by a user. The identifier may be a part of (or the entirety of) a conventional attribute value. Alternatively, such an identifier may be specified that can be understood by the jobnet definition pre-processing program 103 solely for the association function. The jobnet definition pre-processing program 103 removes, from a jobnet defined by a user, information that is unnecessary for a jobnet management program before sending the definition to the jobnet management program.

The jobnet management program has a user interface unit (UI unit) 111, a jobnet control unit 112, and a database 113, and performs, under operation by a user, processing related to jobnets such as definition of a jobnet, execution of a jobnet, monitoring of a jobnet, and operation of a jobnet.

The jobnet management program shown in the drawing is integration of the jobnet management program 101 provided in the storage management server 1, the jobnet management program 201 provided in the storage management client 2, the jobnet management program 301 provided in the storage management agent 3, and the jobnet management program 401 provided in the application server 4.

In many cases, the user interface unit 111 is in the storage management client 2. And, upon receiving an input from a user, the user interface unit 111 presents the user with data (for example, the jobnet operation state). The jobnet control unit 112 interprets the contents of a job defined to a jobnet and stores this information as jobnet information 116 in the database 113. The jobnet control unit 112 also instructs a job execution program 130 to execute a job as defined. The jobnet control unit 112 receives an event to control a jobnet. The job execution program 130 may be included in the jobnet management program.

A storage management program has a user interface unit (UI unit) 121, a resource control unit 122, and a database 123, and performs, under operation by a user, processing related to resources such as display of a resource, monitoring of a resource, and operation of a resource.

The storage management program shown in the figure is integration of the storage management program 102 provided in the storage management server 1, the storage management program 202 provided in the storage management client 2, and the storage management program 302 provided in the storage management agent 3.

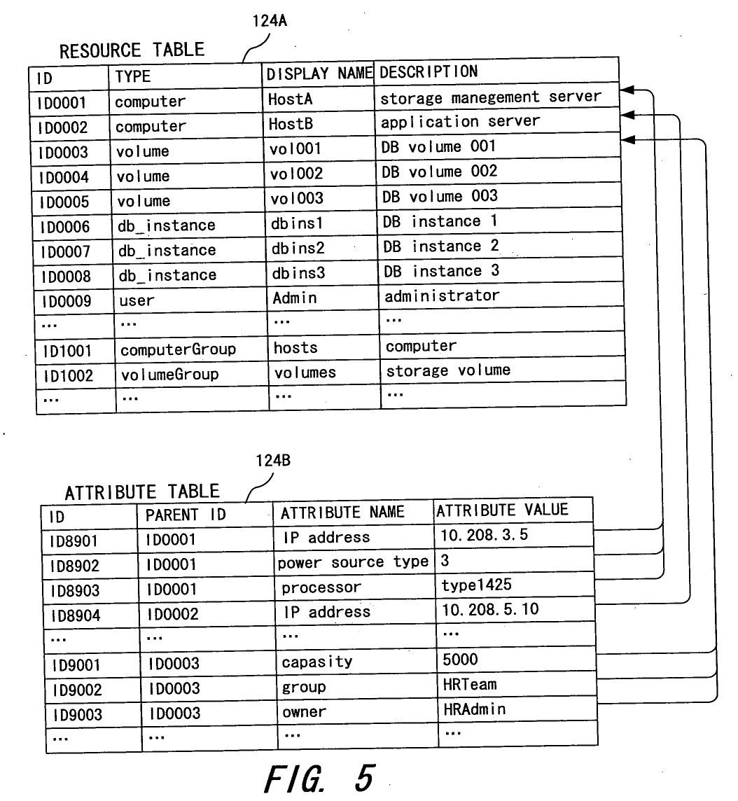

In many cases, the user interface (UI) unit 121 is in the storage management client 2 and, upon receiving an input from a user, presents the user with data (for example, the storage operation state). The resource control unit 122 controls resources 61, which are subjects of storage management, by collecting information such as resource attributes, the resource state, and the association between resources and storing the collected information in resource information 124 (FIG. 5A) of the database 123. The resource control unit 122 also sets and updates the attribute value of a resource. When there is a change in resource information, the resource control unit 122 calls up the user interface unit 121 as need arises and updates display on a GUI (Graphical User Interface).

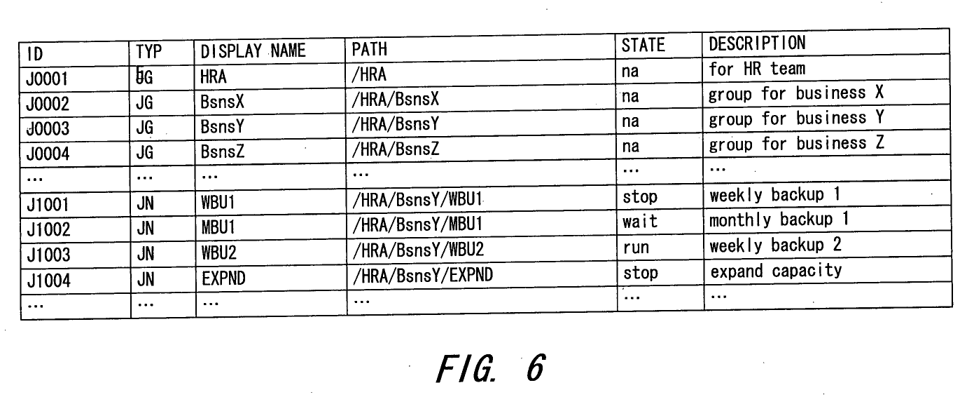

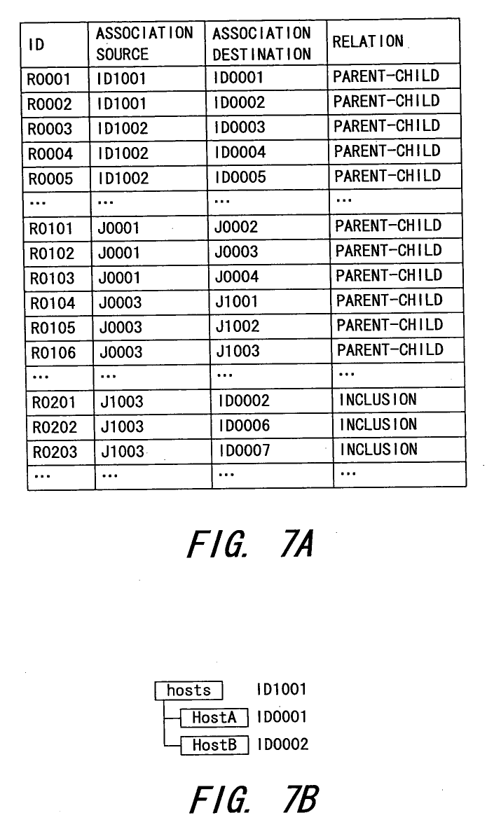

Association information 126 is constituted of a jobnet, and an association source and association destination of the jobnet as well (FIG. 7A to FIG. 7E). Jobnet information 125 (FIG. 6) is constituted of schematic data of the jobnet information 116 stored in the database 113.

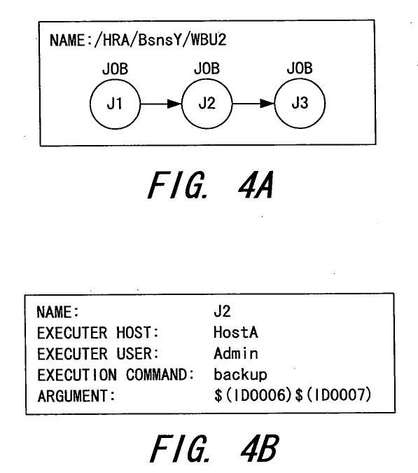

FIG. 4A and FIG. 4B are explanatory diagrams of a jobnet according to the first embodiment.

FIG. 4A shows the configuration of the jobnet. A jobnet defined by a user is composed of plural jobs J1, J2 and J3, which are executed by the job execution program 130 in the stated order. The jobnet is named as “/HRA/BsnsY/WBU2”.

FIG. 4B shows a definition example of the job J2 shown in FIG. 4A. Defined to each job are a job name, the name of a host where the job is executed, the name of a user who executes the job, an execution command, an argument of the command, and so forth. An identifier is specified for an argument defined to a job. The identifier is distinguished from a normal character string by being sandwiched between “$(“ and ”)” as in $(ID0006) and $(ID0007). However, the identifier may be written simply as ID0006 or ID0007 when it has a special prefix that discriminates the identifier from a normal character string.

An argument (parameter) defined to a job is usually an arbitrary character string, and what argument is definable varies depending on the specification of the command executed as a job. In the case of utilizing an identifier of a resource, whether a display name of the resource or a part of attributes of the resource is necessary determines a definition method to be employed. For instance, when a resource has “ID9999” as its identifier, the argument defined is “ID9999.get(“ElementName”)” if the display name of the resource is to be utilized as the command argument, while “ID9999.get(“Att1”)” is defined if the value of a certain attribute “Att1” is to be utilized. What argument is to be defined may be determined in advance and, for example, the initial setting is to utilize the display name.

The arguments $(ID0006) and $(ID0007) are replaced with dbins1 and dbins2, respectively, by the jobnet definition pre-processing program 103 to be handed over to the jobnet management program. The substitution follows the resource information 124.

FIG. 5 are configuration diagrams of the resource information 124 according to the first embodiment.

The resource information 124 is composed of a resource table 124A and an attribute table 124B.

The resource table 124A stores a resource identifier (ID), a resource type, a display name of a resource, and a resource description in a manner that makes the association clear. The attribute table 124B stores attributes of resources associated with the resources. Specifically, the attribute table 124B stores an identifier (ID) of an attribute, an identifier of a resource to which the attributes is added (parent ID), and the name and value of the attribute. The resource table 124A and the attribute table 124B are associated with each other by the parent ID in the attribute table 124A and the resource ID in the resource table 124B.

If resource identifiers stored in the resource information 124 are identifiers of CIM (Common Information Model) regulated by DMTF (Distributed Management Task Force), a storage management program that supports a multi-vendor environment can be implemented with ease.

The table configurations of the resource information 124 shown in FIG. 5 are merely an example, and different table configurations may be employed as long as resources are managed by resource IDs. For instance, an attribute field may be provided in the resource table so that different tables are used for different resources.

Resources that are management object here are not limited to storage devices and data in a database, and could be server hosts which provide business services or individual files on the server hosts.

FIG. 6 is a schematic diagram of the jobnet information 125 according to the first embodiment.

The jobnet information 125 includes a jobnet identifier (ID), a jobnet type, a display name of a jobnet, a jobnet path name, a jobnet execution state, and a jobnet description in a manner that makes the association clear. The jobnet type is information on whether an ID of a jobnet is of jobnet group (JG) or of jobnet (JN). A jobnet path name is the name of a path in the jobnet management program and is used to uniquely designate a job group or a jobnet to the jobnet management program.

The table configuration of the jobnet information 125 shown in FIG. 6 is merely an example and a different table configuration may be employed as long as each jobnet is managed by a jobnet ID. For instance, the jobnet information 125 and the resource information 124 may be handled in an integrated manner.

FIG. 7A to FIG. 7E are configuration diagrams of the association information 126 according to the first embodiment.

The association information 126 includes an identifier (ID) of a jobnet, an identifier of an association source of the jobnet, an identifier of an association destination of the jobnet, and the relation between the association source and the association destination in a manner that makes the association clear. The term “parent-child” stored in a relation field of the association information indicates that the two have a parent-child relation when displayed in tree format. The term “inclusion” indicates that a resource which is the association destination is included in a jobnet which is the association source.

The table configuration of the association information 126 shown in FIG. 7A is merely an example and a different table configuration may be employed.

FIG. 7B to FIG. 7E are conceptual diagrams about the relation between an association source and an association destination.

According to R0001 and R0002 of the association information 126, HostA (the storage management server) of ID0001 and HostB (the application server) of ID0002 belong to a host computer of ID1001 and have a parent-child relation with the host computer (FIG. 7B). With R0003 to R0005 of the association information 126, the parent-child relation between volumes can be known (FIG. 7C).

With R0101 to R0106 of the association information 126, it is shown that a job group BsnsX (a group for Business X) of J0002, a job group BsnsY (a group for Business Y) of J0003, and a job group BsnsZ (a group for Business Z) of J0004 belong to a job group HRA (for an HR team) of J1001 and have a parent-child relation with HRA. It is also shown that a jobnet WBU1 (weekly backup 1) of J1001, a jobnet MBU1 (monthly backup) of J1002, and a jobnet WBU2 (weekly backup 2) of J1003 belong to the job group BsnsY (the group for Business Y) of J003 and have a parent-child relation with BsnsY (FIG. 7D).

According to R0201 to R0203 of the association information 126, HostB (the application server) of ID0002, dbins1 (DB instance 1) of ID0006, and dbins2 (DB instance 2) of ID0007 are included in the jobnet WBU2 and have an inclusion relation with WBU2 (FIG. 7E).

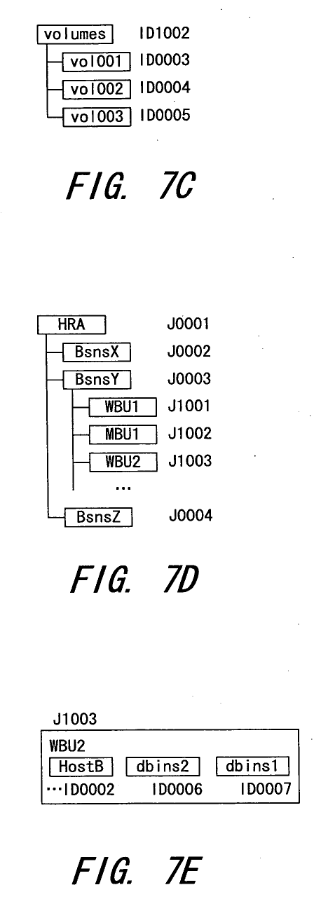

FIG. 8 is a flowchart of processing by the jobnet definition pre-processing program according to the first embodiment.

First, a jobnet to be executed is designated and a method of processing the jobnet is determined taking into account an argument specified for a jobnet execution command as well as an option specified. For instance, a processing method for when resources overlap and a processing method for when an error takes place are determined (Step S101). An argument (parameter) defined to a job is usually an arbitrary character string, and what argument is definable varies depending on the specification of the command executed as a job. In the case of utilizing an identifier of a resource, whether a display name of the resource or a part of attributes of the resource is necessary determines a definition method to be employed. For instance, when a resource has “ID9999” as its identifier, the argument defined is “ID9999.get(“ElementName”)” if the display name of the resource is to be utilized as the command argument whereas “ID9999.get(“Att1”)” is defined if the value of a certain attribute “Att1” is to be utilized. What argument is to be defined may be determined in advance and, for example, the initial setting is to utilize the display name.

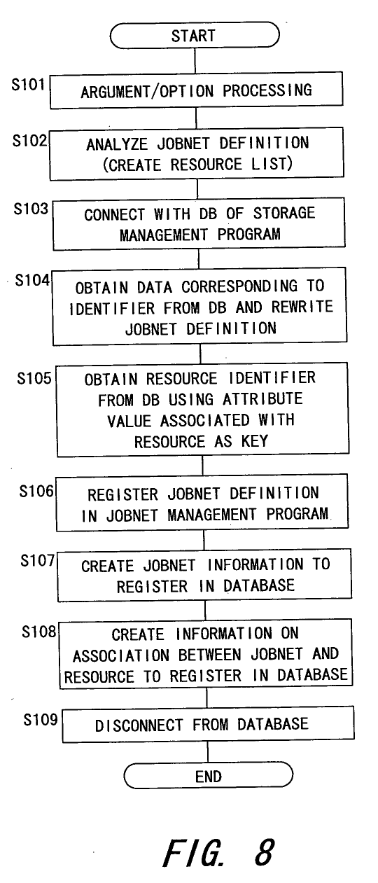

Then the jobnet is analyzed to create a list of resources utilized upon execution of this jobnet (resource list) (Step S102). The resource list crated here is composed of an identifier list (FIG. 9A) and an attribute list (FIG. 9B).

Thereafter, in Step S103, the jobnet definition pre-processing program 103 makes a connection with the database 123 of the storage management program to make data stored in the database 123 usable (readable and writable).

The resource information 124 is searched to obtain, from the database, data that corresponds to the identifier. The ID in the definition of the jobnet is rewritten and substituted with a display name or an attribute, thereby converting the jobnet into an executable format (Step S104).

In Step S105, the resource information 124 is again searched to obtain, from the database, the identifier (ID) of the resource with the value of an attribute that is associated with the resource as a key, and the obtained ID is registered in the attribute list (FIG. 9B). Alternatively, resource identifiers obtained from the database may be presented as conversion options to a user allowing the user to choose a resource identifier to be registered.

The jobnet converted into an executable format is sent to the user interface unit 111 of the jobnet management program to register the jobnet in the jobnet information 116 of the database 113 of the jobnet management program (Step S106).

Outline of the jobnet is registered in the jobnet information 125 of the database 123 of the storage management program, and a jobnet ID used in the storage management program 102 is obtained (Step S107).

The association between the jobnet ID and the ID of a resource included in the jobnet is registered in the association information 126 of the database 123 (Step S108). In short, the ID of a resource included in the definition of the jobnet and the ID of a resource having the attribute value of the job are registered in the association information 126.

Thereafter, the connection with the database 123 of the storage management program is released (Step S109), and ends the jobnet definition pre-processing.

FIG. 9A to FIG. 9C are schematic diagrams of a resource list according to the first embodiment.

The resource list is not stored in any database. The data configuration of the resource list is such that data in the list is extracted onto a memory while the jobnet definition pre-processing program is executed. The resource list is composed of an identifier list (FIG. 9A) and an attribute list (FIG. 9B and FIG. 9C).

The identifier list (FIG. 9A) stores an identifier (ID), path name, and attribute name of a resource described in the jobnet in an associative manner.

The attribute list (FIG. 9B) is a list of attributes (e.g., “host”) associated with a resource of the storage management program 102 among attributes of a job or of a jobnet. Specifically, the attribute list stores an attribute arrangement according to the path name of a job or the path name of a jobnet. An attribute arrangement stores the attribute name of a job or the attribute name of a jobnet, the attribute value of a job or the attribute value of a jobnet (only those associated with a resource of the storage management program 102), and a resource identifier (ID). Although only an executer host corresponding to a resource type “computer” and an executer user corresponding to a resource type “user” are stored in the attribute arrangement example shown in FIG. 9B, any resource can be specified as long as it is a resource managed by the storage management program and is clearly distinguished as one of attributes of a jobnet.

No resource identifier is listed immediately after the jobnet analysis. Then a value obtained by searching the database based on the attribute value of a job or the attribute value of a jobnet is stored as a resource identifier (FIG. 9C).

When there is more than one resource that matches the attribute value of a job or the attribute value of a jobnet, an interface is necessary which enables a user to choose an appropriate one from these resources.

As has been described, in the first embodiment, a resource identifier is clearly described as an argument in the definition of a management procedure (jobnet). Then a function to read the identifier is provided as the jobnet definition pre-processing program 103, and the storage management program is provided with association information in which a management subject, a management procedure, and the association between the subject and the procedure are registered. This enables a user to easily define the association between a management procedure and a management subject.

Since the relation between a management procedure and a management subject can be known with ease, an unintended relation between a management procedure and a management subject can be found at an early stage, allowing prompt correction of the unintended relation. Also, when there is a trouble in a management procedure, which management subject is affected by the trouble can instantly be known and can be dealt with early.

In addition, the first embodiment makes it possible to associate a jobnet with a management subject without modifying an existing job execution program.

Next, a second embodiment of this invention will be described.

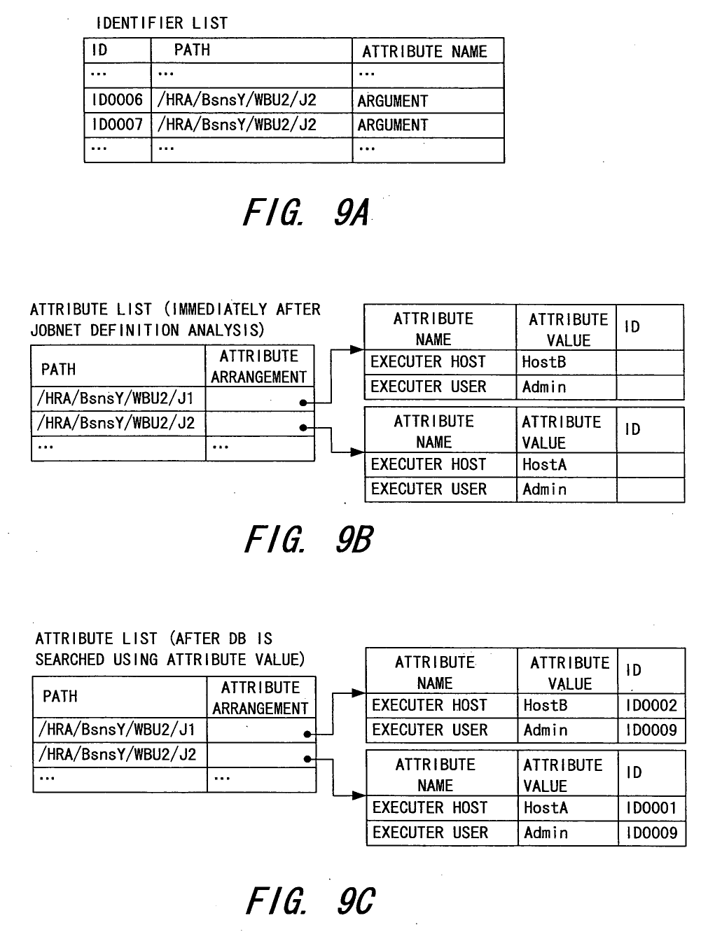

FIG. 10 is a functional block diagram of the second embodiment.

In the second embodiment, the storage management server 1 has a template processing program 104 in place of the jobnet definition pre-processing program 103 of the first embodiment. The template processing program 104 executes, in addition to the processing of the jobnet definition pre-processing program described in the first embodiment, processing of creating a jobnet by applying a template definition or parameters inputted by a user to a template.

The database 123 of the storage management program stores template information 127 in addition to the resource information 124, the association information 126, and the jobnet information 125. With the template information 127 stored in the database 123, a template can be operated through the user interface 121 of the storage management program.

Alternatively, the template information may be managed within the template processing program.

The association information 126 may store a template association in addition to ajobnet-resource association.

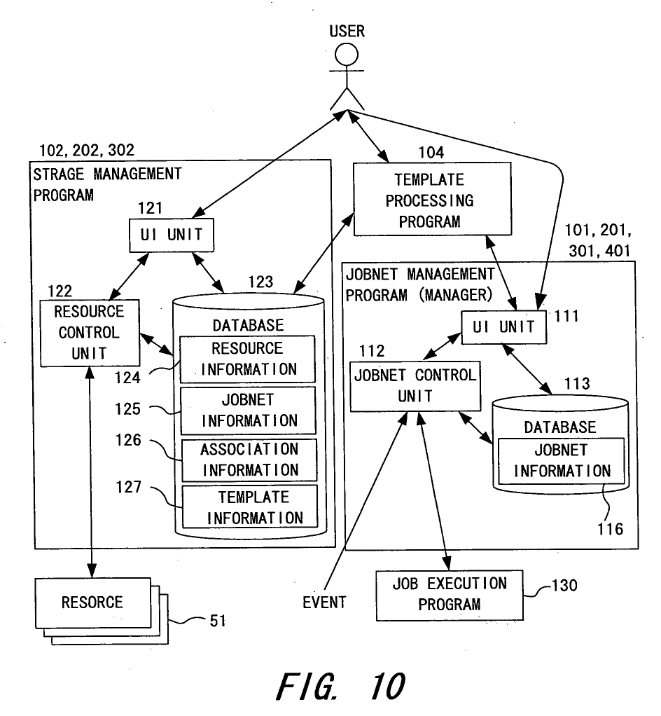

FIG. 11 shows a definition example of the job J2 according to the second embodiment. In this example, the argument directly specifies a resource identifier unlike the job definition example of the first embodiment described above.

Alternatively, a list of resources of the type that is specified in the jobnet pre-processing performed by the jobnet definition pre-processing program 103 may be presented to a user so that the user can select a resource.

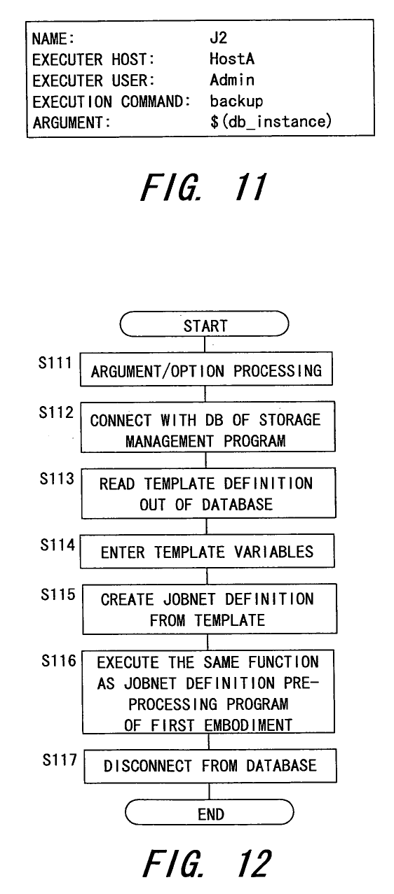

FIG. 12 is a flowchart of processing by the template processing program according to the second embodiment.

First, a jobnet to be processed is specified and a method of processing the jobnet is determined taking into account an argument specified for a jobnet execution command as well as an option specified. For instance, a processing method for when resources overlap and a processing method for when an error takes place are determined (Step S1).

Then, in Step S103, the template processing program 104 makes a connection with the database 123 of the storage management program to make data stored in the database 123 usable (readable and writable).

The template information 127 is searched to read a template definition specified by a user (Step S113). A question about variables defined to the template is displayed to the user and, upon reception of an input that answers the question, every variable defined to the template is set (Step S114). Thereafter, the variables set in Step S114 are applied to the template read in Step S113 to create a definition of the jobnet (Step S115).

Subsequently, the same processing as the jobnet definition pre-processing described above (Steps S102 to S108 in FIG. 8) is executed to register information on the association between a jobnet ID and a resource ID in the association information 126 of the database 123 (Step S116).

Thereafter, the connection with the database 123 of the storage management program is then released (Step S117), and ends the template processing.

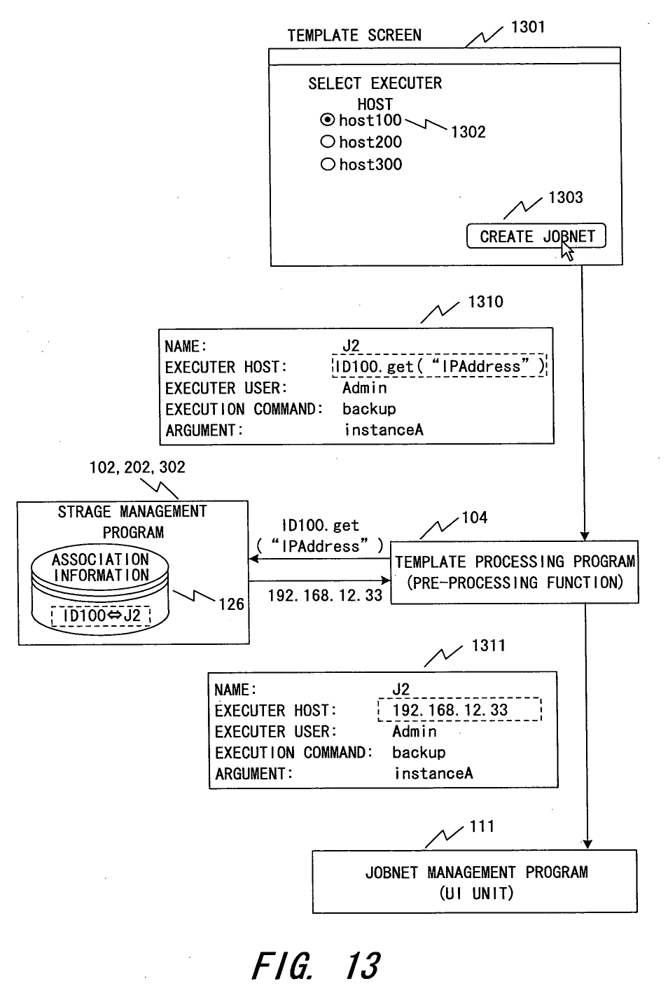

FIG. 13 is an explanatory diagram of a screen and pre-processing of the template processing program according to the second embodiment.

A template screen 1301 is a screen for accepting an input of parameters from a user based on a defined template. In the example of FIG. 13, a list 1302 of subject hosts (host names) and a button 1303 for executing creation of a jobnet are on the template screen 1301 in order to make the user choose a host that executes the job. As the user instructs the template processing program 104 to create a jobnet using this screen, pre-processing is executed including associating a jobnet identifier with a resource identifier and converting job argument information. Described next is the flow of the pre-processing in the example shown in FIG. 13.

A user chooses, on the template screen 1301, host 100 as a job executer host. The template holds a resource identifier corresponding to the host chosen and an attribute (IP address) to be obtained.

The template processing program 104 first creates a job 1310 using the resource identifier of the host chosen. At this point, a resource identifier and an attribute to be obtained are written as the executer host. In this example, “Id100.get(“IPAddress”)” is written in the job in order to obtain the IP address of resource ID 100 corresponding to host 100 chosen by the user.

Next, the template processing program 104 registers the association between the jobnet J2 and resource ID100 in the association information 126 of the database of the storage management program. The template processing program 104 then obtains the IP address value of ID 100.

Lastly, the template processing program 104 converts the executer host part of the job definition into the obtained IP address (1311). The created jobnet is registered in the jobnet management program 111.

The converted IP address is displayed in the case where this job definition is referred to through a client GUI of the jobnet management program after the registration to the jobnet management program 111.

As has been described, the second embodiment has the following effects in addition to the effects of the first embodiment. The second embodiment utilizes templates enabling a user who does not have knowledge of jobnet to associate a created jobnet with a management subject by merely choosing a template and inputting several parameters with the help of a wizard. The second embodiment eliminates the need for a template user to consider an identifier or the like of a management subject since the creator of a template can define association by an identifier of a management subject. In particular, the second embodiment is applicable to a multi-vendor environment with the use of CIM identifiers.

Given above are examples of applying this invention to storage system management. However, this invention is also applicable to management of general computer systems other than storage system management.

While the present invention has been described in detail and pictorially in the accompanying drawings, the present invention is not limited to such detail but covers various obvious modifications and equivalent arrangements, which fall within the purview of the appended claims.

What is claimed is:

1. A computer system comprising:
a storage system provided with plural disk drives and a disk array control unit, and
a management device provided with a control unit that manages the storage system system by using a jobnet; wherein
the control unit is provided with a jobnet definition pre-processing unit, a jobnet management unit, and a storage management unit; and
the jobnet definition pre-processing unit:
analyzes the jobnet to extract a resource utilized upon execution of the jobnet and registering the extracted resource in a resource list,
making a connection with a database of the storage management system,
searching the database to obtain data corresponding to an identifier of a resource that is included in the jobnet, and converting the jobnet into an executable format by translating the identifier with a display name or attribute of the resource,
searching the database to obtain an identifier corresponding to a resource in an attribute of a job that is included in the jobnet to register the identifier in the resource list,
registering the jobnet that has been converted into an executable format in jobnet information of the jobnet management unit and in jobnet information of the storage management unit,
obtaining an identifier of the jobnet from the storage management unit,
registering an association between the jobnet identifier and the resource identifier in association information of the storage management unit, and
disconnecting connection with the database of the storage management unit.

2. A computer system comprising:
a storage system provided with plural disk drives and a disk array control unit, and
a management device provided with a control unit that manages the storage system by using a jobnet, wherein
the control unit:
obtains data corresponding to an identifier of a resource that is included in the jobnet,
converts the jobnet into an executable format by translating the identifier with a display name or attribute of the resource, and
registers an association between a jobnet identifier and a resource identifier in a database.

3. The computer system according to claim 2, wherein the control unit obtains an identifier corresponding to a resource in an attribute of a job that is included in the jobnet, and registers the identifier in a resource list.

4. The computer system according to claim 2, wherein the control unit obtains data corresponding to an identifier of a resource that is included in the jobnet, and translates the identifier with a display name or attribute of the resource.

5. The computer system according to claim 2, wherein
the jobnet is an integrated management procedure composed of plural processing, and includes identifiers to specify resources that execute the respective processing and identifiers to specify resources that are subjects of the processing,
the computer system further comprises a host computer which utilizes data stored in the disk devices of the storage system, and
the host computer is a resource that executes processing included in the jobnet.

6. The computer system according to claim 2, wherein
the jobnet is an integrated management procedure provided with plural processing, and includes identifiers to specify resources that execute the respective processing and identifiers to specify resources that are objects of the processing,
the computer system further comprises a host computer, which is a resource that executes the processing, and
a resource that is a subject of the processing contains a file used by the computer system.

7. A pre-processing method for a jobnet which is used in a computer system including a storage system provided with plural disk drives and a disk array control unit, and a management device provided with a control unit that manages the storage system by using a jobnet, the pre-processing method comprising:
obtaining data corresponding to an identifier of a resource that is included in the jobnet,
converting the jobnet into an executable format by translating the identifier with a display name or attribute of the resource; and
registering an association between a jobnet identifier and a resource identifier in a database.

8. The pre-processing method according to claim 7, further comprising obtaining an identifier corresponding to a resource in an attribute of a job that is included in the jobnet, and registering the identifier in a resource list.

9. The pre-processing method according to claim 7, further comprising obtaining data corresponding to an identifier of a resource that is included in the jobnet, and translating the identifier with a display name or attribute of the resource.

10. A computer program product for controlling a computer system including a storage system provided with plural disk drives and a disk array control unit and a management device provided with a control unit that manages the storage system by useing a jobnet, the program controlling the computer system to:
obtain data corresponding to an identifier of a resource that is included in the jobnet,
convert the jobnet into an executable format by translating the identifier with a display name or attribute of the resource; and
register an association between a jobnet identifier and a resource identifier.

11. The computer program product according to claim 10, further controlling the computer system to: execute the procedure of obtaining an identifier corresponding to a resource in an attribute of a job that is included in the jobnet, and register the identifier in a resource list.

12. The computer program product according to claim 10, further controlling the computer system to: execute the procedure of obtaining data corresponding to an identifier of a resource that is included in the jobnet, and translate the identifier with a display name or attribute of the resource.
